(19) United States
(12) Patent Application Publication
(10) Pub. No.: US 2026/0061442 A1
(43) Pub. Date: Mar. 5, 2026

(54) TRIGGER DISPENSING DEVICE

(71) Applicant: GUALA DISPENSING S.P.A., Alessandria (IT)

(72) Inventor: Riccardo ALLUIGI, Alessandria (IT)

(21) Appl. No.: 19/106,131

(22) PCT Filed: Jun. 14, 2023
(86) PCT No.: PCT/IB2023/056115

§ 371 Date: Feb. 24, 2025

(30) Foreign Application Priority Data
Oct. 14, 2022 (IT) 102022000021228

(51) Int. Cl. B05B 11/10

(52) U.S. Cl. CPC B05B 11/104; B05B 11/1047; B05B 11/1057

(57) ABSTRACT

A main valve body of a trigger dispensing head is made in one piece and has a substantially flat body base, an annular inner body wall, a shutter, an annular dispensing lip, a dispensing passage, and an outer body wall for protecting the annular dispensing lip.

### FIELD OF THE INVENTION

The present invention is in the field of trigger dispensing devices for the delivery of a product, for example for household hygiene, air freshening, personal hygiene and care, clothing care and the like.

### PRIOR ART

Such devices are enormously popular and appreciated by users for the practicality of use, versatility and, lastly, for the possibility of being used more than once by appropriately refilling the product within the bottle. Several hundred million pieces are produced every year.

The Applicant is a world leader in the production and sale of such products and is the holder of numerous patents. For example, the Applicant is the holder of the International Application WO-A1-2014/016709.

A further example of an embodiment is described in the document WO-A1-2022/103355.

Given the high production volumes, it is necessary for the trigger dispensing head, which is then coupled to a bottle, to comprise components that ensure a fast assembly speed whilst maintaining high head operating reliability, also following harsh transportation conditions, as may be case with transport by commercial online services couriers, or following the accidental dropping of the device, due, for example, to a clumsy user.

Some dispensing head components are particularly critical and require greater attention, for example during the step of transporting the component from the molding station, where it is molded, to the assembly station, where it is assembled together with the other components in order to form the dispensing head. These problems concern, for example, thee valve devices that, when mounted onto the dispensing head, make it possible to regulate the flow of the product.

Damage to such devices, for example the permanent deformation of some portions, results in difficulty in mounting the head, which may then lead to assembly station stoppages, and malfunctioning of the head, in particular during the suction and delivery steps, which are immediately perceived by the user.

### OBJECT OF THE INVENTION

The object of the present invention is that of implementing a trigger dispensing head provided with a main valve body that meets the requirements of the field and overcomes the drawbacks mentioned above.

This object is achieved by a main valve body according to claim 1. The dependent claims disclose further advantageous embodiments of the invention.

### BRIEF DESCRIPTION OF THE DRAWINGS

The features and advantages of the trigger dispensing head and of the main valve body according to the present invention will be apparent from the description given below, given by way of non-limiting example in accordance with the figures in the appended tables, wherein:
FIG. 1 shows a trigger dispensing device comprising a bottle and a trigger dispensing head according to one embodiment of the invention;
FIG. 2 shows a trigger dispensing head in separate parts, according to one embodiment of the present invention;
FIG. 3a is a cross-sectional view of the dispensing head of FIG. 2 in an initial or resting configuration;
FIG. 3b is an enlarged view of a portion of the dispensing head of FIG. 3a;
FIG. 4a is a cross-sectional view of the dispensing head of FIG. 2, in a dispensing configuration;
FIG. 4b is an enlarged view of a portion of the dispensing head of FIG. 4a;
FIG. 5a is a cross-sectional view of the dispensing head of FIG. 2, in a suction configuration;
FIG. 5b is an enlarged view of a portion of the dispensing head of FIG. 5a;
FIG. 6a shows a main valve body, according to one embodiment of the invention;
FIG. 6b is a side view of the main valve body of FIG. 6a;
FIG. 6c is a plan view of the main valve body of FIG. 6a.

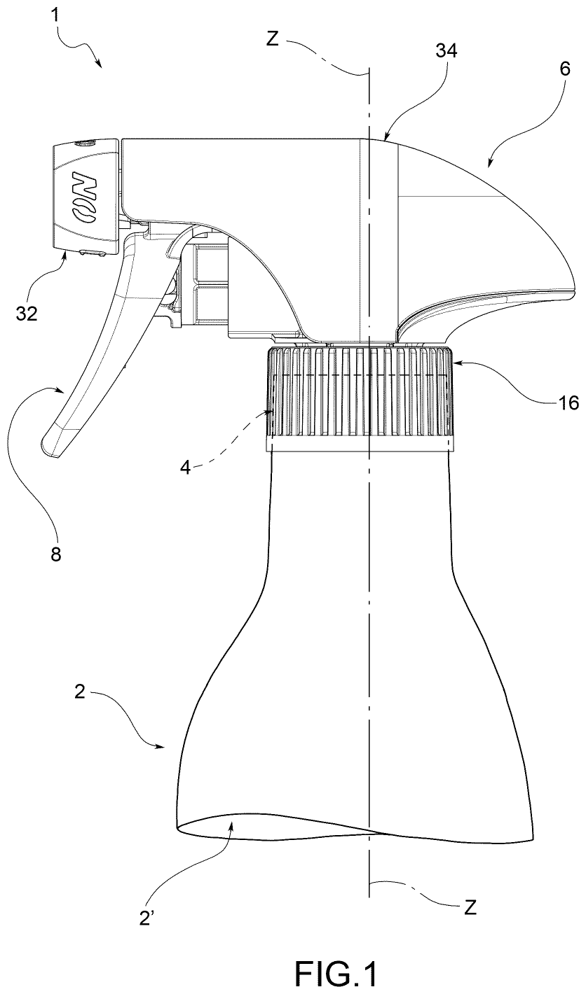

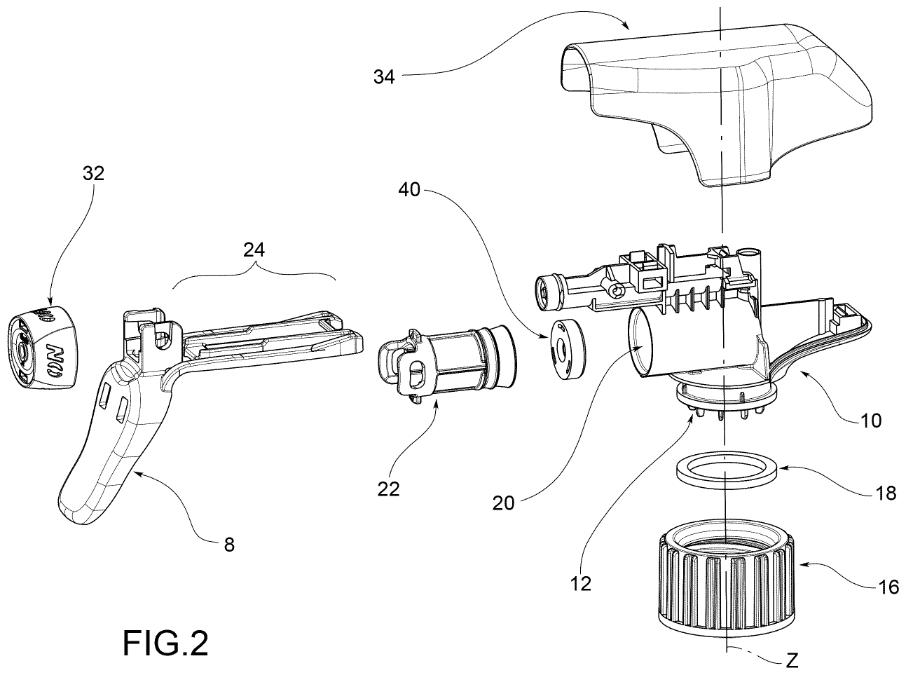

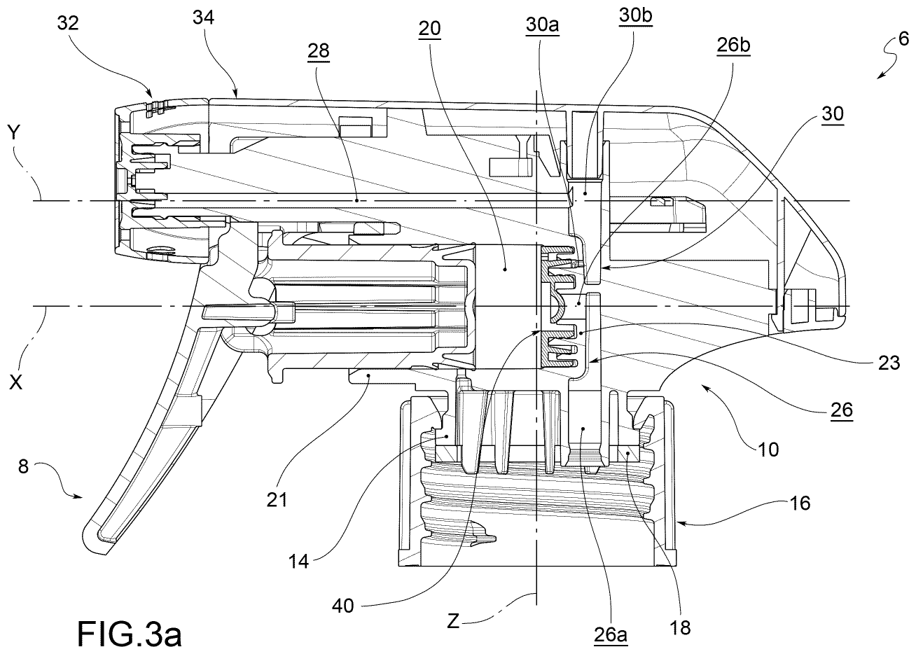

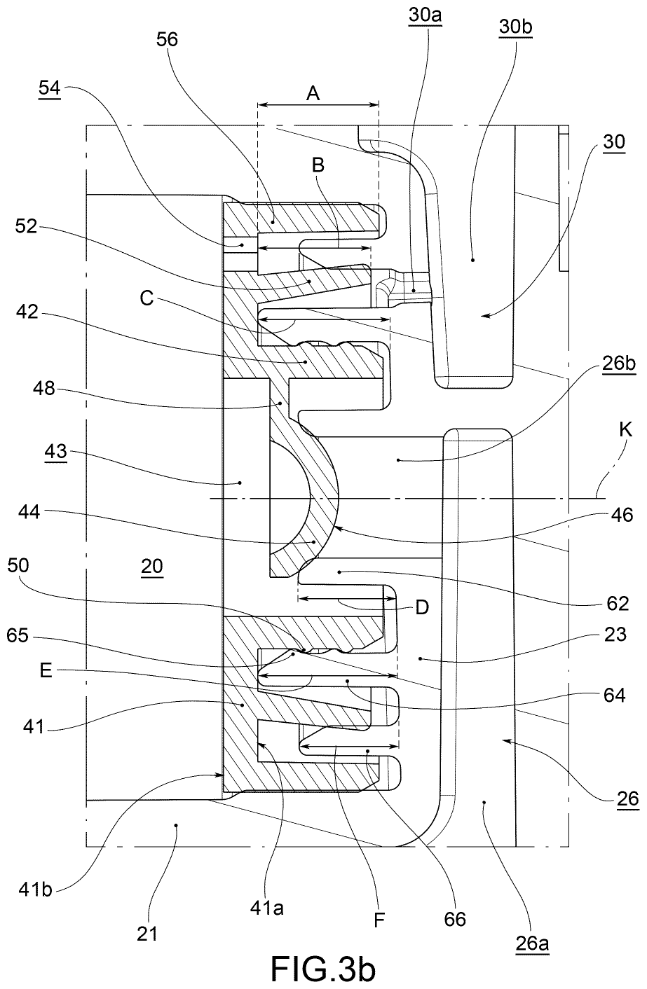

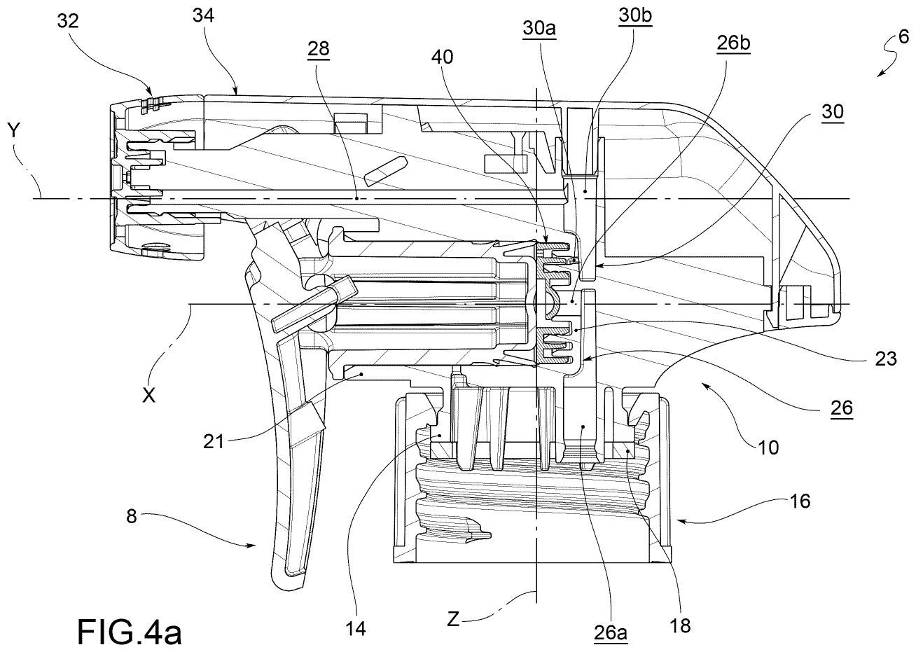

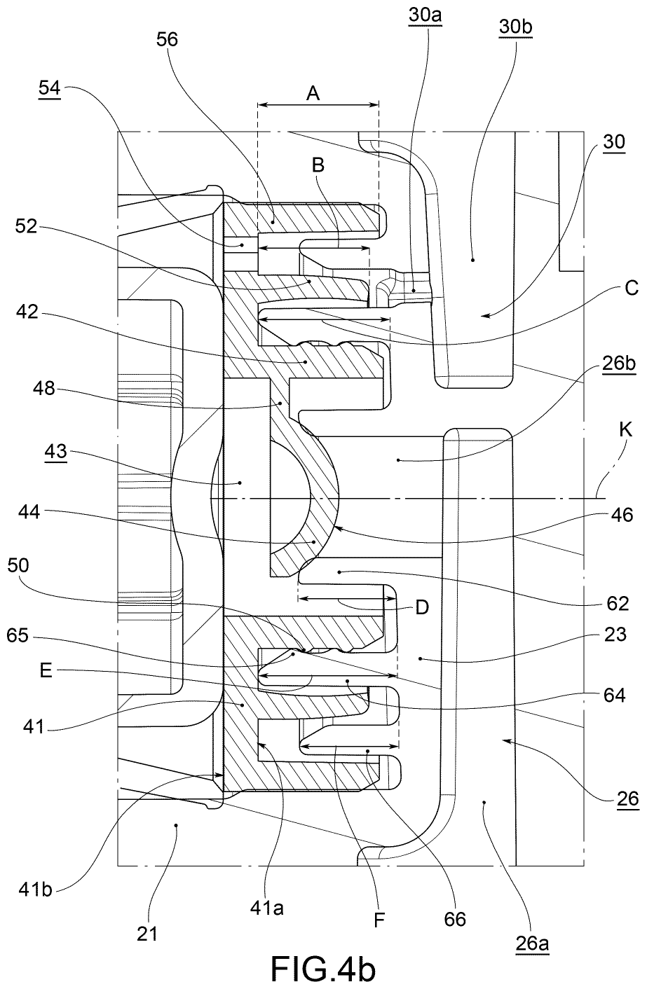

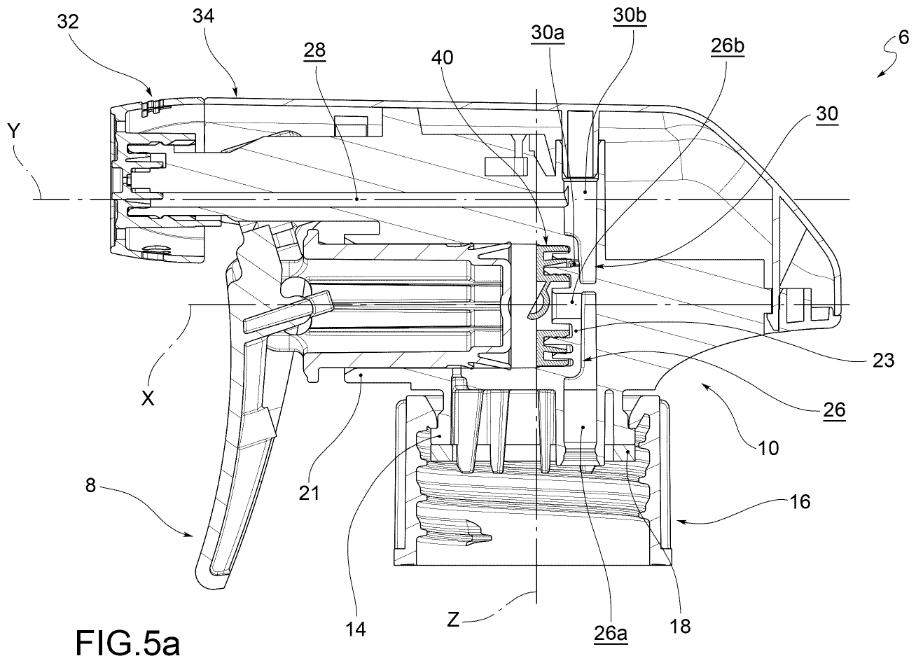

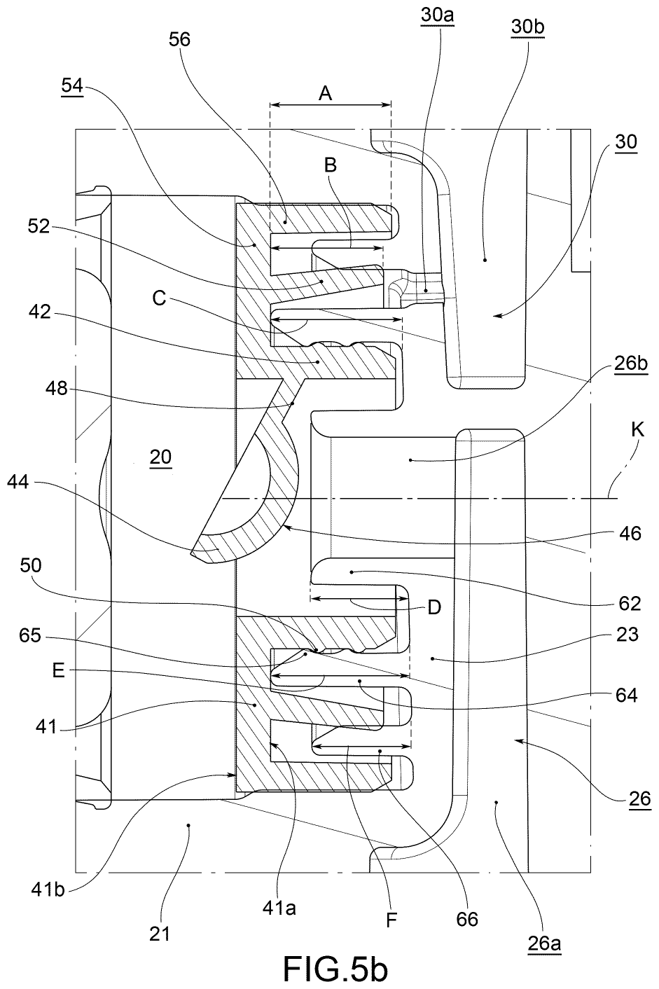

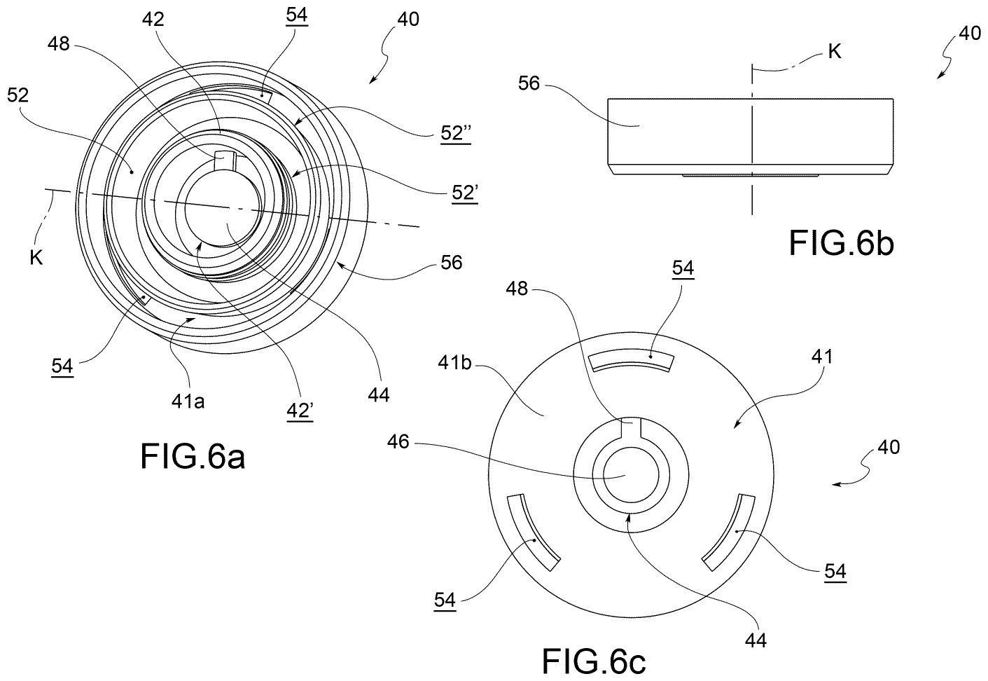

### DESCRIPTION OF A PREFERRED EMBODIMENT OF THE INVENTION

A trigger 1 dispensing device for the manual delivery of a product, comprising a bottle 2 having a bottle compartment 2′for containing the product and provided with a neck 4, which is for example threaded, and a trigger dispensing head 6 that may be applied to the bottle 2, for example may be screwed onto the neck 4, which head is provided with a manually actuatable trigger 8 for the suction of the product from the bottle and dispensing said product into the external environment.

According to a preferred embodiment, the head 6 comprises a frame 10 for supporting components, preferably made as one piece from a plastics material, for example using a polyolefin polymer material, for example polypropylene (PP) or recycled polypropylene (rPP), for example by means of injection molding.

The frame 10 comprises a connection region 12 for applying the frame to the neck of the bottle; for example, the connection region 12 comprises an annular connection wall 14.

The head 6 furthermore comprises a ring nut 16 that is suitable for being coupled to the connection region 12 of the frame 10 and screwed to the neck 4 of the bottle 2, by means of rotation around a vertical axis Z. Preferably, a sealing ring 18 is located between the connection wall 14 and the neck 4.

Preferably, the ring nut 16 is made as one piece from a plastics material, for example using a polyolefin polymer material such as polypropylene (PP). The head 6 furthermore comprises a pressure chamber 20 that is generally cylindrical, having a chamber axis X that, preferably, intersects with the vertical axis Z, preferably orthogonally. The pressure chamber 20 is laterally delimited by an annular chamber wall 21, connected at least in one part to the connection portion 12, and to the bottom by a bottom wall 23.

Preferably, the pressure chamber 20 is implemented within the frame 10 and said chamber wall 21 and said bottom wall 23 are portions of said frame 10.

The head 6 furthermore comprises a piston 22 sliding in a fluid-tight manner in the pressure chamber 20, along said chamber axis X. In particular, the piston 22 slides between an initial, or resting, position (FIG. 3), in which the volume within the pressure chamber 20 for containing the product is at a maximum, and a final position (FIG. 4), in which the volume within the pressure chamber 20 for containing the product is at a minimum zero.

Preferably, the piston 22 is made as one piece from a plastics material, for example using a polyolefin polymer material such as polypropylene (PP), recycled polypropylene (rPP) or high-density polyethylene (HDPE).

The head 6 furthermore comprises the trigger 8 which is suitable for being manually actuated, preferably applied to the frame 10 and operationally connected to the piston 22 in order to actuate it in translation within the pressure chamber 20.

The head 6 furthermore comprises elastic return means that are suitable for permanently biasing the piston 22 towards the initial position. According to a preferred embodiment, said return means comprise a flexible return portion 24 of the trigger 8. In other words, the return means are integrated into the trigger 8. The piston 22 is translated from the initial position or from an intermediate position towards the final position during a step of product dispensing, in which it is actuated by the trigger, and from the final position or an intermediate position towards the initial position during a step of suction, in which it is actuated by the return means.

Preferably, the trigger 8 is made as one piece from a plastics material, for example using a polyolefin polymer material such as polypropylene (PP) or recycled polypropylene (rPP).

The head 6 furthermore comprises a suction pipe 26 that is suitable for placing the bottle compartment in fluidic communication with the pressure chamber 20. For example, the suction pipe 26 is implemented within the frame 10 and comprises a first suction stretch 26a that opens out into the bottle compartment, preferably parallel to the vertical axis Z, and a second suction stretch 26b that opens out into the pressure chamber 20, in communication with the first suction stretch 26a, preferably parallel to the chamber axis X. For example, the second suction stretch 26b crosses the bottom wall 23 of the pressure chamber 20.

The head 6 furthermore comprises a dispensing pipe 28 that opens out towards the external environment and that preferably extends along a dispensing axis Y, preferably parallel to the chamber axis X. Preferably, the dispensing pipe 28 is located within the frame 10.

The head 6 furthermore comprises an outlet pipe 30 that is suitable for placing the pressure chamber 20 in fluidic contact with dispensing pipe 28. For example, the outlet pipe 30 is implemented within the frame 10 and comprises a first outlet section 30a that crosses the bottom wall 23 and opens out into the pressure chamber 20, preferably parallel to the chamber axis X, and a second outlet section 30a that is in communication with the first outlet section 30a and connected to the dispensing pipe 28, preferably parallel to the vertical axis Z.

The head 6 furthermore preferably comprises a nozzle 32 that is either fixed or rotating, and that is applied to the free end of the dispensing pipe 28 for modifying the spray patterns of the dispensed jet or for allowing for the dispensing pipe to be closed in order to impede the dispensing of the product.

Preferably, the nozzle 32 is made as one piece from a plastics material, for example using a polyolefin polymer material such as polypropylene (PP).

The head 6 furthermore preferably comprises a shell 34 that is applied to the frame 10, for example by snapping, in order to cover the frame 10 and those components supported by said frame or else implemented therewithin.

Preferably, the shell 34 is made as one piece from a plastics material, for example using a polyolefin polymer material such as polypropylene (PP) or recycled polypropylene (rPP).

The head 6 further comprises valve means suitable for adjusting the product flow from the bottle compartment to the pressure chamber 20 and from the pressure chamber 20 to the external environment.

Said valve means comprise a main valve body 40, made as one piece from a polyolefin polymer material, for example low density polyethylene (LDPE) or ethylene thermoplastic octene (TPEO), obtained by means of injection molding.

The main body 40 is applicable to the bottom wall 23 in such a way as to be housed within the pressure chamber 23.

The main body 40 comprises a substantially flat body base 41, having an inner face 41a and an opposite outer face 41b. The body base 41 has a base passage 43 passing through the thickness. With the main body 40 applied to the bottom wall 23, the outer face 41b is turned towards the piston 22, whilst the inner face 41a is turned towards the bottom wall 23.

The main body 40 furthermore comprises an annular inner body wall 42, projecting from the inner face 41a of the body base 41, having a body axis K that, when the main body 40 is applied to the bottom wall 23, is parallel to the second suction stretch 26b of the suction pipe 26. The inner body wall 42 delimits in an annular manner an internal compartment 42′.

The main body 40 furthermore comprises a shutter 44, for example in the form of a portion of a spherical cap, which is preferably hollow on one side and provided with a shutter outer surface 46 that is, for example, spherical.

The main body 40 furthermore comprises a flexible shutter arm 48 that connects the shutter 44 to the inner body wall 42; the shutter 44 is therefore supported cantilevered by the inner body wall 42 by means of the shutter arm 48.

Preferably, the shutter 44 and the shutter arm 48 are contained within the inner compartment 42′and are lower than the outer face 41b.

Preferably, furthermore, the inner body wall 42 comprises at least one circumferential prominence 50, arranged externally, for connecting the main body 40 to the bottom wall 23.

The main body 40 furthermore comprises an annular flexible dispensing lip 52, axially projecting from the inner face 41a of the body base 41, preferably coaxial to the inner body wall 42, arranged radially externally to the inner face 42.

Preferably, the dispensing lip 42 has an overall truncated cone shape that converges towards the inner face 41a.

The main body 40 has, furthermore, at least one dispensing passage 54 passing through the body base 41, arranged radially externally to the dispensing lip 52. For example, the main body 40 has three dispensing passages 44 between the outer face 41b and the inner face 41a. For example, each dispensing passage 44 has a circumferentially elongated form ; for example, the dispensing passages 44 are angularly equidistant.

The main body 40, finally, has an annular outer body wall 56, projecting from the inner face 41a of the body base 41, preferably coaxial to the body axis K, arranged radially externally to the dispensing lip 52.

In other words, the dispensing lip 52 is arranged in an intermediate radial position between the inner body wall 42 and the outer body wall 56. An inner intermediate compartment 52′is delimited between the inner body wall 42 and the dispensing lip 52; an outer intermediate compartment 52″ is delimited between the dispensing lip 52 and the outer body wall 56. The dispensing passages 54 are arranged radially between the dispensing lip 52 and the outer body wall 56 and therefore open out into the outer intermediate compartment 52″.

Preferably, the outer body wall 56 has a cylindrical outer side surface 58, having a single predetermined diameter, which constitutes the outer peripheral surface of the main body 40.

The outer body wall 56 has a predefined axial extension A that, preferably, is greater or equal to the axial extension B of the dispensing lip 52 (A≥B) ; the inner body wall 42 has a predefined axial extension C that is preferably greater than or equal to the axial extension B of the dispensing lip 52 (C≥B) ; preferably, furthermore, the axial extension C of the inner body wall 42 is greater than or equal to the axial extension A of the outer body wall 56 (C≥A).

In other words, preferably, the dispensing lip 52 is completely contained within a compartment that is externally peripherally delimited by the outer body wall 56, in such a way as to be protected.

The bottom wall 23 of the pressure chamber 20 comprises an annular inlet wall 62, projecting into the pressure chamber 20 that delimits the second suction stretch 26b.

The bottom wall 23 furthermore comprises an inner intermediate wall 64, arranged radially externally to the inlet wall 62, projecting into the pressure chamber 20. Preferably, the inner intermediate wall 64 has an axial extension D that is greater than the axial extension E of the inlet wall 62 (D>E). Preferably, furthermore, the inner intermediate wall 64 has, externally, at least one annular counter-prominence 65 that is suitable for engaging, by snapping, with the relative prominance 50 of the main body 40.

The bottom wall 23 of the pressure chamber 20 furthermore comprises an annular outer intermediate wall 66, projecting into the pressure chamber 20, arranged radially externally to the inner intermediate wall 64. Preferably, the axial extension D of the inner intermediate wall 64 is greater than the axial extension F of the outer intermediate wall 66 (D>F). The first outlet section 30a opens out into the pressure chamber 20 between the inner intermediate wall 64 and the outer intermediate wall 66.

In one assembly configuration of the dispensing head, when the main body 40 is mounted onto the dispensing head, that is to say applied to the bottom wall 23, the inner body wall 42 of the main body 40 is externally laterally in contact with the inner intermediate wall 64 of the bottom wall 23. Preferably, the prominences 50 of the inner body wall 42 are engaged with respective counter-prominences 65 of the inner intermediate wall 64, thus ensuring a stable connection between the main body 40 and the bottom wall 23.

In said assembly configuration, the shutter 44 is arranged in such a way as to match the terminal end of the inlet wall 62, in such a way as to close the second suction stretch 26b.

Furthermore, the dispensing lip 52 is arranged radially between the inner intermediate wall 64 and the outer intermediate wall 66, laterally in contact with the outer intermediate wall 66, in such a way as to form a lateral seal between the pressure chamber 20 and the first outlet section 30a.

In other words, the inlet wall 62, the second suction stretch 26b, the shutter 44 and the shutter arm 48 constitute an example of valve suction means; the outer intermediate wall, the dispensing lip 52 and the first dispensing section 30a constitute an example of valve dispensing means.

Finally, preferably, the outer body wall 56 is externally laterally connected to the chamber wall 21.

In one initial or resting configuration (FIGS. 3a and 3b), the piston 22 is in the initial or resting position; the shutter 44 closes the second suction stretch 26b, thereby implementing a seal between the pressure chamber 20 and the suction pipe 26; the dispensing lip 52 closes the first outlet section 30a thereby implementing a seal between the pressure chamber 20 and the outlet pipe 30.

It should be noted that a predefined quantity of product to be delivered may be contained within the pressure chamber 20.

During a step of dispensing (FIGS. 4a and 4b), by actuating the trigger 8, the piston 22 translates towards the final position and the increase in pressure within the pressure chamber 20 causes the opening of the valve dispensing means. In other words, the dispensing lip 52 flexes and detaches from the outer intermediate wall 66, causing the passage of the product from the pressure chamber 20 to the outlet pipe 30 (and from the same, by means of the dispensing pipe 28, towards the external environment). The shutter 44, conversely, is configured to be pushed, by means of the pressure within the pressure chamber 20, against the inlet wall 62, and therefore to implement a seal between the pressure chamber 20 and the suction pipe 26 that prevents the product from returning from the pressure chamber 20 to the suction pipe 26.

At the end of the step of dispensing, the piston 22 is in the final position or else in an intermediate position.

During a step of suction (FIGS. 5a and 5b), by releasing the trigger 8, due to the action of the return means and the decrease in pressure within the pressure chamber 20, the piston 22 translates towards the initial position, thereby provoking the opening of the valve suction means and closure of the valve dispensing means. In other words, the shutter 44, by virtue of the flexing of the shutter arm 48, detaches, at least in part, from the inlet wall 62, provoking the suction of the product from the dispensing pipe 28 to the pressure chamber 20. The dispensing lip 52, conversely, is configured so as to flex, by means of the decrease in pressure, towards the outside, and therefore to implement a seal between the outlet pipe 30 and the pressure chamber 20, that prevents the product from returning from the outlet pipe 30 to the pressure chamber 20.

The dispensing head 6 furthermore preferably comprises venting means that are suitable for allowing air to enter from the external environment into the bottle compartment during the step of suction.

According to an embodiment variant, the main body of the valve means includes a plurality of shutter arms that Support the shutter.

According to a further embodiment variant, the outer body wall has a minor axial extension of the axial extension of the dispensing lip, for example greater than or equal to ⅓ of the axial extension of the dispensing lip, preferably greater than or equal to ½ of the axial extension of the dispensing lip, preferably greater than or equal to ⅔ of the axial extension of the dispensing lip. Nonetheless, the dispensing lip, during transport or assembly, is adequately protected.

According to a still further embodiment variant, the dispensing head is connected to the bottle by means of a bayonet connection.

Innovatively, the dispensing head according to the present invention meets the needs of the industry and overcomes the aforesaid disadvantages, insofar as the valve means described above make it possible to adequately protect the dispensing lip, thereby avoiding damage during bulk transportation of the valve bodies or else during manipulation when assembling the head.

Advantageously, furthermore, the dispensing head according to the present invention has a high degree of recyclability insofar as 98% by weight of the components used may molded from PP; the main valve body may instead be molded from LDPE or TPEO, but the weight is so contained that the head may be considered to be a single material, according to industry regulations.

Furthermore, advantageously, the heavier components, that is to say the trigger, the piston, the nozzle, the frame, the shell and the ring nut, which together constitute 70% of the weight of the head, may be molded from recycled polypropylene (rPP).

Advantageously, furthermore, the weight of the head, according to the present invention, is extremely contained, which the Applicant has estimated to be about 20% less than similar devices on the market.

It is clear that a person skilled in the art could make changes to the dispensing head, and in particular the main body of the valve means, with the aim of satisfying contingent needs. Such modifications are contained within the scope of protection as defined by the following claims.

1-18. (canceled)

19. A main valve body for a trigger dispensing head, comprising:
a substantially flat body base comprising an inner face and an opposite outer face, provided with a base passage passing through a thickness of the substantially flat body base;
an annular inner body wall protruding from the inner face, having a body axis orthogonal to the inner face, which surrounds the base passage, wherein the annular inner body wall delimits an inner compartment;
a shutter arranged in the inner compartment to make valve suction means for the trigger dispensing head;
an annular dispensing lip, axially protruding from the inner face, arranged radially externally with respect to the annular inner body wall, flexible to make valve dispensing means for the trigger dispensing head;
at least one dispensing passage passing through the thickness of the substantially flat body base, arranged radially outside the annular dispensing lip; and
an annular outer body wall, protruding axially from the inner face, arranged radially outwards with respect to the annular dispensing lip for protecting the annular dispensing lip.

20. The main valve body of claim 19, wherein the annular outer body wall has an axial extension either greater than or equal to ⅓ of an axial extension of the annular dispensing lip.

21. The main valve body of claim 19, wherein the annular inner body wall has an axial extension either greater than or equal to an axial extension of the annular dispensing lip.

22. The main valve body of claim 19, wherein the annular inner body wall has an axial extension either greater than or equal to an axial extension of the annular outer body wall.

23. The main valve body of claim 19, wherein the annular dispensing lip has a truncated cone shape converging towards the inner face.

24. The main valve body of claim 19, wherein the annular inner body wall externally comprises at least one circumferential prominence.

25. The main valve body of claim 19, further comprising a flexible shutter arm that connects the shutter to the annular inner body wall.

26. The main valve body of claim 19, made in one-piece of polyolefin polymer material, optionally the polyolefin polymer material being low-density polyethylene or ethylene thermoplastic octene.

27. The main valve body of claim 19, wherein the annular outer body wall has a cylindrical outer side surface having a single predetermined diameter, which constitutes an outer peripheral surface of the main valve body.

28. A trigger dispensing head for dispensing a product, comprising:
a pressure chamber for pressurizing a predetermined amount of the product;
a suction pipe for drawing a predetermined amount of the product into the pressure chamber;
an outlet pipe for dispensing a predetermined amount of the product from the pressure chamber; and
a main valve body comprising:
a substantially flat body base comprising an inner face and an opposite outer face, provided with a base passage passing through a thickness of the substantially flat body base;
an annular inner body wall protruding from the inner face, having a body axis orthogonal to the inner face, which surrounds the base passage, wherein the annular inner body wall delimits an inner compartment;
a shutter arranged in the inner compartment to make valve suction means for the trigger dispensing head;
an annular dispensing lip, axially protruding from the inner face, arranged radially externally with respect to the annular inner body wall, flexible to make valve dispensing means for the trigger dispensing head;
at least one dispensing passage passing through the thickness of the substantially flat body base, arranged radially outside the annular dispensing lip; and
an annular outer body wall, protruding axially from the inner face, arranged radially outwards with respect to the annular dispensing lip for protecting the annular dispensing lip,
wherein the main valve body is housed in the pressure chamber.

29. The trigger dispensing head of claim 28, wherein the pressure chamber is delimited laterally by a chamber wall and at a bottom by a bottom wall, the main valve body being applied to the bottom wall.

30. The trigger dispensing head of claim 29, wherein the bottom wall comprises an annular inlet wall protruding into the pressure chamber, which delimits a second suction stretch of the suction pipe, and the shutter is engageable in a fluid-tight manner with a terminal end of the annular inlet wall.

31. The trigger dispensing head of claim 30, wherein the bottom wall comprises an inner intermediate wall, arranged radially outside the annular inlet wall, protruding into the pressure chamber and the annular inner body wall of the main valve body is engaged with the inner intermediate wall of the bottom wall.

32. The trigger dispensing head of claim 31, wherein the bottom wall comprises an annular outer intermediate wall, protruding into the pressure chamber, arranged radially outside the inner intermediate wall, and the annular dispensing lip is engageable in a fluid-tight manner with the annular outer intermediate wall.

33. The trigger dispensing head of claim 29, wherein the annular outer body wall of the main valve body is externally laterally in contact with the chamber wall.

34. A trigger dispensing device, comprising:
the trigger dispensing head of claim 28; and
a bottle for containing the product,
wherein the trigger dispensing head is connected to the bottle through a threaded connection.

35. A trigger dispensing device, comprising:
the trigger dispensing head of claim 28; and
a bottle for containing the product,
wherein the trigger dispensing head is connected to the bottle through a bayonet connection.

36. A trigger dispensing head for a trigger dispensing device for delivery of a product, comprising:
a frame made in one-piece of polypropylene or recycled polypropylene;
a ring nut for connecting the frame to a bottle of the trigger dispensing device, made in one-piece of polypropylene;
a piston sliding in a fluid-tight manner in a pressure chamber of the frame, made in one-piece of polypropylene or recycled polypropylene;
a main valve body housed in the pressure chamber to adjust a flow of the product during a suction step and a dispensing step, made in one-piece of low-density polyethylene or thermoplastic ethylene octene;
a trigger for moving the piston in the dispensing step and in the suction step, made in one-piece of polypropylene or recycled polypropylene;
a nozzle applied to an outlet of a dispensing pipe of the frame for controlling a shape of a dispensed jet and/or closing the outlet, made in one-piece of polypropylene or recycled polypropylene; and
a shell applied to the frame to cover the frame and at least part of components supported by the frame, made in one-piece of polypropylene or recycled polypropylene.

37. The main valve body of claim 19, wherein the annular outer body wall has an axial extension either greater than or equal to ½ of an axial extension of the annular dispensing lip.

38. The main valve body of claim 19, wherein the annular outer body wall has an axial extension either greater than or equal to ⅔ of an axial extension of the annular dispensing lip.

39. The main valve body of claim 19, wherein the annular outer body wall has an axial extension either greater than or equal to an axial extension of the annular dispensing lip.
